(19) United States
(12) Patent Application Publication
(10) Pub. No.: US 2021/0358674 A1
(43) Pub. Date: Nov. 18, 2021

(54) INTEGRATED INDUCTIVE DEVICE

(71) Applicant: SANTAK ELECTRONIC (SHENZHEN) CO., LTD., Shenzhen (CN)

(72) Inventors: Pingchang Lin, Shenzhen (CN); Hualiang Li, Shenzhen (CN); Jian Wei, Shenzhen (CN)

(21) Appl. No.: 17/245,314

(22) Filed: Apr. 30, 2021

(30) Foreign Application Priority Data
May 15, 2020 (CN) 202020817938.3

(51) Int. Cl. H01F 27/255; H01F 27/28

(52) U.S. Cl. CPC H01F 27/255; H01F 27/2866

(57) ABSTRACT

The present utility model provides an integrated inductive device, which includes: a first end magnetic core and a second end magnetic core arranged oppositely, each of the first end magnetic core and the second end magnetic core including three areas; three columnar magnetic cores located between the first end magnetic core and the second end magnetic core; and three inductive coils each wound on the periphery of a corresponding columnar magnetic core and located between two corresponding areas of the first end magnetic core and the second end magnetic core. The integrated inductive device of the present utility model is structurally compact, increases the space utilization rate, and reduces the cost.

### TECHNICAL FIELD

The present utility model relates to an inductive device, in particular to an integrated inductive device.

### BACKGROUND

A conventional three-phase alternating-current or three-way interleaved parallel inductive device includes three independently arranged inductors each provided with its own magnetic core and inductive coil, and the three inductors are arranged at certain intervals. Therefore, the existing inductive device occupies a large space and has low integration level, which reduces the power density and space utilization rate of applicable places. Moreover, the consumption of materials is large, which is not conducive to cost control.

### SUMMARY

In view of the aforementioned technical problems in the existing technology, the present utility model provides an integrated inductive device, which includes: a first end magnetic core and a second end magnetic core arranged oppositely, each of the first end magnetic core and the second end magnetic core including three areas; three columnar magnetic cores located between the first end magnetic core and the second end magnetic core; and three inductive coils each wound on the periphery of a corresponding columnar magnetic core and located between two corresponding areas of the first end magnetic core and the second end magnetic core.

Preferably, the first end magnetic core and the second end magnetic core are shaped like a triangular plate.

Preferably, the three inductive coils respectively include a first rotational axis, a second rotational axis and a third rotational axis which are parallel to one another and perpendicular to the first end magnetic core and the second end magnetic core. Preferably, any two of the first rotational axis, the second rotational axis and the third rotational axis are equally spaced.

Preferably, the first end magnetic core includes a first end surface and a second end surface which are arranged oppositely, and the second end surface of the first end magnetic core is provided with three first recesses which match the shape of one end of each of the three columnar magnetic cores and into which the columnar magnetic cores can be inserted. The second end magnetic core includes a third end surface and a fourth end surface which are arranged oppositely, and the fourth end surface of the second end magnetic core is provided with three second recesses which match the shape of the other ends of the three columnar magnetic cores and into which the columnar magnetic cores can be inserted.

Preferably, the first end magnetic core is provided with a first magnetic core through hole running through the first end surface and the second end surface, the first magnetic core through hole being located in the middle of the three first recesses. The second end magnetic core is provided with a second magnetic core through hole running through the third end surface and the fourth end surface, the second magnetic core through hole being located in the middle of the three second recesses.

Preferably, the integrated inductive device further includes a first insulating cover located between the first end magnetic core and the three inductive coils and a second insulating cover located between the second end magnetic core and the three inductive coils.

Preferably, the first insulating cover is identical with the second insulating cover. The first insulating cover includes an insulating sheet having the same shape as the second end surface of the first end magnetic core and provided with three through holes respectively aligned with the three first recesses; an annular flange fixed at the edge of the insulating sheet and extended in a direction toward the second end surface of the first end magnetic core; and three clamping rings located on the insulating sheet, which extend in a direction toward the three first recesses and respectively match the shape of inner sidewalls of the three first recesses.

Preferably, the first insulating cover is provided with a cover through hole located in the middle of the three through holes.

Preferably, the integrated inductive device further includes three insulating papers sheathing outer sidewalls of the three columnar magnetic cores.

Preferably, each of the three inductive coils includes two outlet ends, and insulating markers are fixed on the outlet ends of the three inductive coils.

Preferably, the three inductive coils are vertically wound flat wires and have the same number of turns and winding direction.

Preferably, the first end magnetic core and the second end magnetic core have the same shape, the three inductive coils have the same shape, and the three columnar magnetic cores have the same shape.

The integrated inductive device of the present utility model is smaller in volume and structurally compact, thus increasing the space utilization rate. Through symmetrical arrangement, magnetic flux is distributed more uniformly. Moreover, material is saved by hollowing out the non-main magnetic field portions of the end magnetic core, thus reducing cost while maintaining performance.

BRIEF SUMMARY OF THE DRAWINGS

The embodiments of the present utility model will be further explained in reference to the accompanying drawings, in which:

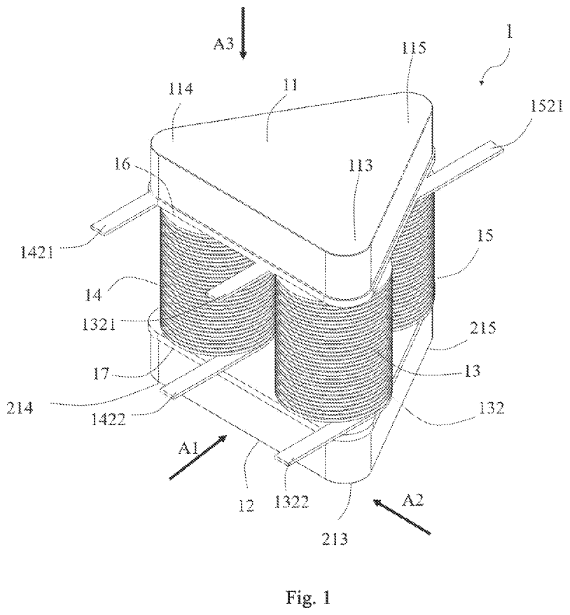

FIG. 1 is a schematic perspective diagram of an integrated inductive device according to a first embodiment of the present utility model;

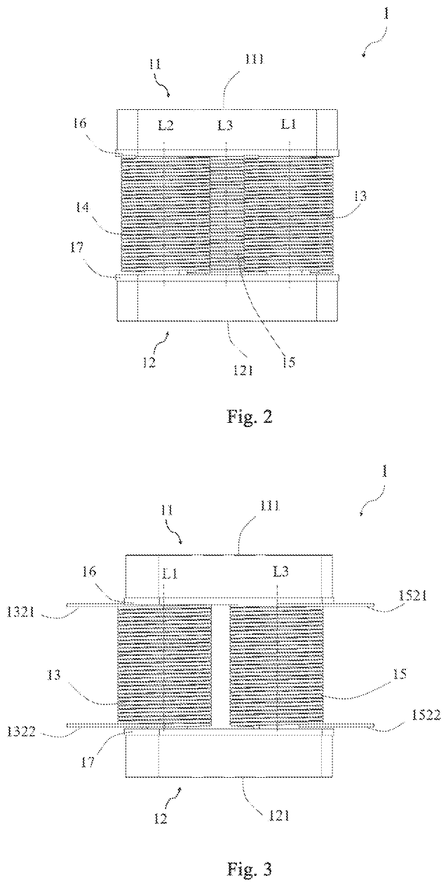

FIG. 2 is a schematic plan view of the integrated inductive device shown in FIG. 1 as viewed along a direction indicated by arrow A1;

FIG. 3 is a schematic plan view of the integrated inductive device shown in FIG. 1 as viewed along a direction indicated by arrow A2;

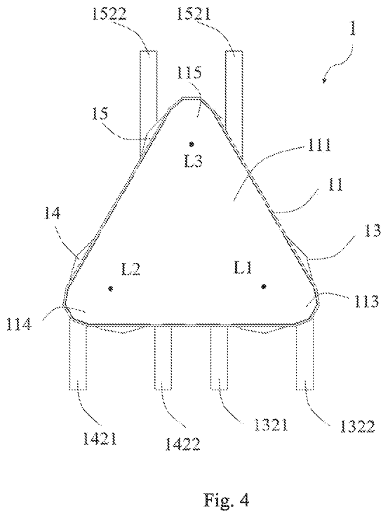

FIG. 4 is a schematic plan view of the integrated inductive device shown in FIG. 1 as viewed along a direction indicated by arrow A3;

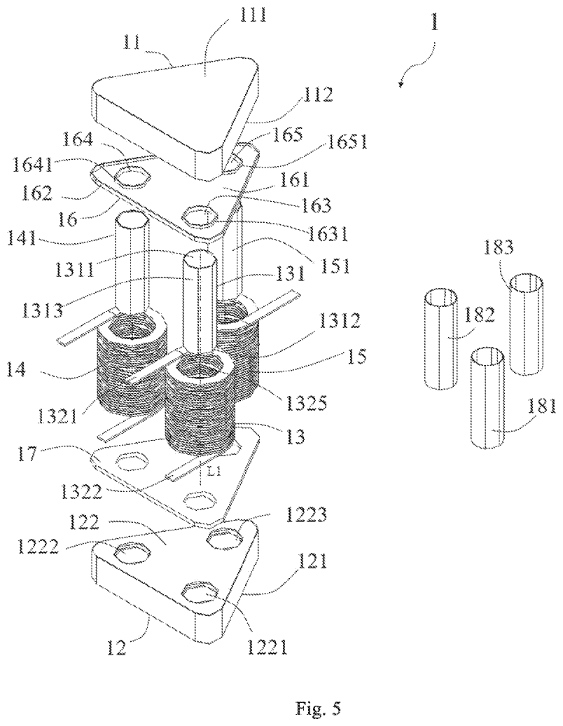

FIG. 5 is an exploded diagram of the integrated inductive device shown in FIG. 1;

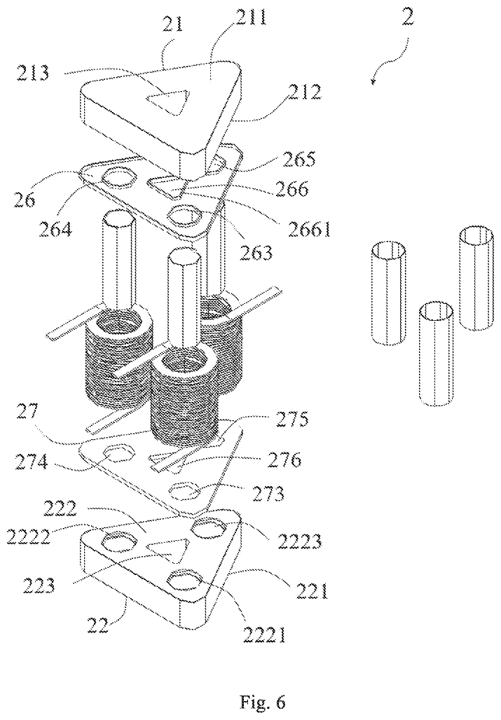

FIG. 6 is an exploded diagram of an integrated inductive device according to a second embodiment of the present utility model;

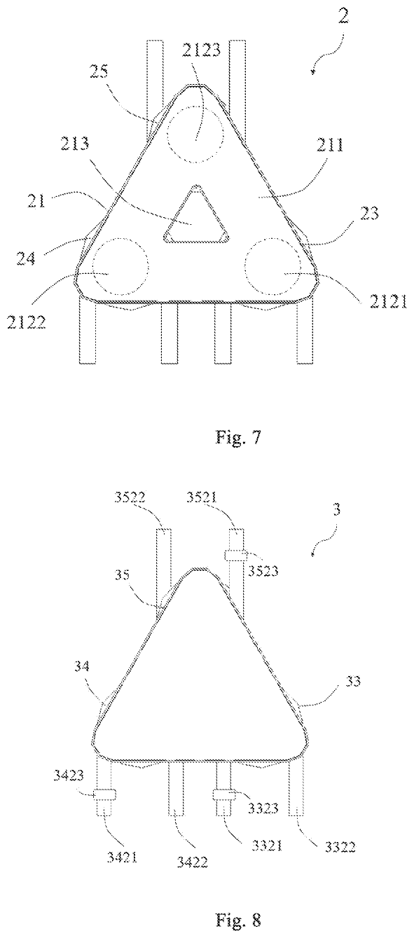

FIG. 7 is a schematic plan view of the integrated inductive device shown in FIG. 6 in an assembled state as viewed along a direction from a first end magnetic core to a second end magnetic core; and

FIG. 8 is a schematic plan view of an integrated inductive device according to a third embodiment of the present utility model in an assembled state as viewed along a direction from a first end magnetic core to a second end magnetic core.

### DETAILED DESCRIPTION

In order to make the objective, technical solution and advantages of the present utility model clearer, the present utility model will be further described in detail below by way of specific embodiments in reference to drawings.

### First Embodiment

FIG. 1 is a schematic perspective diagram of an integrated inductive device according to the first embodiment of the present utility model. As shown in FIG. 1, the integrated inductive device 1 is substantially of a triangular prism-shaped structure, and includes: a first end magnetic core 11 and a second end magnetic core 12 arranged oppositely; three columnar magnetic cores (described in detail below with reference to FIG. 5) located between the first end magnetic core 11 and the second end magnetic core 12; inductive coils 13, 14, 15 wound on the peripheries of the three columnar magnetic cores; an insulating cover 16 located between one end of each of the inductive coils 13, 14, 15 and the first end magnetic core 11; and an insulating cover 17 located between the other end of each of the inductive coils 13, 14, 15 and the second end magnetic core 12.

The first end magnetic core 11 and the second end magnetic core 12 are shaped like a triangular plate and arranged in parallel. The first end magnetic core 11 includes three areas 113, 114, 115, which are located near three vertexes of the first end magnetic core, and the second end magnetic core 12 includes three corresponding areas 213, 214, 215.

The inductive coil 13 is located between the area 113 of the first end magnetic core 11 and the area 213 of the second end magnetic core 12, the inductive coil 14 is located between the area 114 of the first end magnetic core 11 and the area 214 of the second end magnetic core 12, and the inductive coil 15 is located between the area 115 of the first end magnetic core 11 and the area 215 of the second end magnetic core 12. The inductive coils 13, 14, 15 are all formed by winded flat wires. The inductive coil 13 includes a first outlet end 1321 and a second outlet end 1322, the inductive coil 14 includes a first outlet end 1421 and a second outlet end 1422, and the inductive coil 15 includes a first outlet end 1521 and a second outlet end (not shown in FIG. 1). The first outlet end 1321 of the inductive coil 13, the first outlet end 1421 of the inductive coil 14 and the first outlet end 1521 of the inductive coil 15 are close to the first end magnetic core 11, and the second outlet end 1322 of the inductive coil 13, the second outlet end 1422 of the inductive coil 14 and the second outlet end of the inductive coil 15 are close to the second end magnetic core 12.

FIG. 2 is a schematic plan view of the integrated inductive device 1 shown in FIG. 1 as viewed in a direction indicated by arrow Al. FIG. 3 is a schematic plan view of the integrated inductive device 1 shown in FIG. 1 as viewed along a direction indicated by arrow A2, where the inductive coil 14 blocked by the inductive coil 13 is not shown in FIG. 3. As shown in FIGS. 2 and 3, the first end magnetic core 11 includes a first end surface 111 and a second end surface (not shown in FIGS. 2 and 3) which are arranged oppositely. The second end magnetic core 12 includes a first end surface 121 and a second end surface (not shown in FIGS. 2 and 3) which are arranged oppositely. The second end surface of the first end magnetic core 11 is parallel to the second end surface of the second end magnetic core 12. The insulating cover 16 covers the second end surface of the first end magnetic core 11, and the insulating cover 17 covers the second end surface of the second end magnetic core 12. The inductive coils 13, 14, 15 have respective axes L1, L2, L3, which are parallel to one another and perpendicular to the second end surface of the first end magnetic core 11 and the second end surface of the second end magnetic core 12. The inductive coils 13, 14, 15 have the same number of turns. Therefore, the inductive coils 13, 14, 15 are firmly clamped between the insulating cover 16 and the insulating cover 17.

FIG. 4 is a schematic plan view of the integrated inductive device 1 shown in FIG. 1 as viewed along a direction indicated by arrow A3. As shown in FIG. 4, the inductive coils 13, 14, 15 are respectively located between two corresponding areas of the first end magnetic core 11 and the second end magnetic core 12, where any two of the axes L1, L2, L3 (shown by black dots in FIG. 4) of the inductive coils 13, 14, 15 are equally spaced.

The first outlet end 1321 and second outlet end 1322 of the inductive coil 13 and the first outlet end 1421 and second outlet end 1422 of the inductive coil 14 are parallel and extend outward along a direction away from the inductive coil 15. The first outlet end 1521 and second outlet end 1522 of the inductive coil 15 are parallel each other and extend outward along a direction away from the inductive coil 13 and the inductive coil 14.

FIG. 5 is an exploded diagram of the integrated inductive device shown in FIG. 1. As shown in FIG. 5, the integrated inductive device 1 further includes columnar magnetic cores 131, 141, 151 and insulating papers 181, 182, 183.

The columnar magnetic cores 131, 141, 151 have the same shape. Only the columnar magnetic core 131 will be taken as an example for illustration hereinafter. The columnar magnetic core 131 includes a first end 1311 and a second end 1312 arranged oppositely, and a middle portion 1313 located therebetween. The columnar magnetic core 131 has an axis perpendicular to the second end surface 112 of the first end magnetic core 11 and the second end surface 122 of the second end magnetic core 12.

The insulating papers 181, 182, 183 are shaped like a cylinder with both ends open, and are respectively used to wrap or sheathe outer sidewalls of the columnar magnetic cores 131, 141, 151.

The first end magnetic core 11 and the second end magnetic core 12 are identical, and are symmetrically arranged with respect to a plane (not shown in FIG. 5) perpendicular to the rotational axis L1 of the inductive coil 13. The second end magnetic core 12 will be taken as an example for illustration hereinafter. The second end surface 122 of the second end magnetic core 12 is provided with recesses 1221, 1222, 1223 which match the shape of the second ends of the columnar magnetic cores 131, 141, 151 and into which the columnar magnetic cores 131, 141, 151 can be inserted Likewise, the second end surface 112 of the first end magnetic core 11 is also provided with recesses (not shown in FIG. 5) which match the shape of the first ends of the columnar magnetic cores 131, 141, 151 and into which the columnar magnetic cores 131, 141, 151 can be inserted.

The inductive coils 13, 14, 15 are substantially of a tubular structure with both ends open, and only the inductive coil 13 will be taken an example for illustration here. The inductive coil 13 is configured to be wound clockwise around its axis L1, and an inner sidewall of the inductive coil 13 defines an accommodating space 1325 for accommodating the middle portion 1313 of the columnar magnetic core 131.

The insulating cover 16 and the insulating cover 17 have the same structure, and only the insulating cover 16 will be taken an example for illustration here. The insulating cover 16 is made of an insulating material, and is substantially shaped like a triangular plate. The insulating cover 16 includes an insulating sheet 161 and an annular flange 162 at the edge of the insulating sheet 161, and the annular flange 162 extends in a direction toward the second end surface 112 of the first end magnetic core 11. The insulating sheet 161 has substantially the same shape as the second end surface 112 of the first end magnetic core 11, so that the insulating cover 16 can be tightly covered the second end surface 112 of the first end magnetic core 11. The insulating sheet 161 is provided with through holes 163, 164, 165, and clamping rings 1631, 1641, 1651 located on the insulating sheet 161. The through holes 163, 164, 165 are respectively aligned with the three recesses (not shown in FIG. 5) on the second end surface 112 of the first end magnetic core 11. The clamping rings 1631, 1641, 1651 extend in a direction toward the three recesses on the first end magnetic core 11, abutting against the sidewalls of the through holes 163, 164, 165, respectively. Inner sidewalls of the clamping rings 1631, 1641, 1651 respectively match outer sidewalls of the columnar magnetic cores 131, 141, 151, and outer sidewalls of the clamping rings 1631, 1641, 1651 respectively match inner sidewalls of the three recesses on the second end surface 112 of the first end magnetic core 11, so that the clamping rings 1631, 1641, 1651 can be clamped with the inner sidewalls of the three recesses on the second end surface 112 of the first end magnetic core 11.

The process of assembling the integrated inductive device 1 will be briefly described below. The insulating paper 181, 182, 183 are respectively wrapped or sheathed on the outer sidewalls of the columnar magnetic cores 131, 141, 151, and three flat wires are respectively wound around the columnar magnetic cores 131, 141, 151 to form the inductive coils 13, 14, 15, or the formed inductive coils 13, 14, 15 are respectively sheathed on the outer sidewalls of the columnar magnetic cores 131, 141, 151. After the clamping rings 1631, 1641 and 1651 on the insulating cover 16 are aligned with the three recesses (not shown in FIG. 5) on the second end surface 112 of the first end magnetic core 11, the insulating cover 16 is covered on the second end surface 112 of the first end magnetic core 11, and after the three clamping rings (not shown in FIG. 5) on the insulating cover 17 are respectively aligned with the three recesses 1221, 1222, 1223 of the second end magnetic core 12, the insulating cover 17 is covered on the second end surface 122 of the second end magnetic core 12. The inductive coils 13, 14, 15 are then placed between the insulating cover 16 and the insulating cover 17. One end of each of the columnar magnetic cores 131, 141, 151 is passed through a respective one of the through holes 163, 164, 165 on the insulating cover 16 and is then tightly inserted into a respective one of the recesses on the first end magnetic core 11, while the other ends of the columnar magnetic cores 131, 141, 151 are respectively passed through the three through holes on the insulating cover 17 and are then tightly inserted into the recesses 1221, 1222, 1223 of the second end magnetic core 12.

According to a method commonly used in the art to evaluate the induction performance of integrated inductive devices, direct-current (DC) biases are applied on the integrated inductive device 1 of the present embodiment to test its inductance value during the increase of DC current, and the results are shown in table 1 below.

TABLE 1
Inductance Values of Integrated Inductive Device
1 Under Different DC Bias Current Intensities

| | Integrated Inductive Device 1 | | |
|---|---|---|---|
| | Inductance Value (μH) | | |
| Current | Inductive | Inductive | Inductive |
| (A) | Coil 13 | Coil 14 | Coil 15 |
| 0 | 164 | 173 | 165 |
| 10 | 160 | 169 | 163 |
| 20 | 146 | 152 | 147 |
| 30 | 112 | 112 | 116 |
| 40 | 86.7 | 86.1 | 86.8 |
| 50 | 73.2 | 72.3 | 72.5 |
| 60 | 62.3 | 60.6 | 61.3 |
| 70 | 52.9 | 50.8 | 51.7 |
| 80 | 44.6 | 42.4 | 43.2 |
| 90 | 37.9 | 35.8 | 36.7 |
| 100 | 32.4 | 30.6 | 31.4 |

It can be seen from table 1 that with the increase of DC bias current intensity, the inductances of the inductive coils in the integrated inductive device 1 all decrease nonlinearly, which is reasonable.

Since the first end magnetic core 11 and the second end magnetic core 12 are shaped like a triangular plate and the inductive coils 13, 14, 15 are respectively located between two corresponding areas of the first end magnetic core 11 and the second end magnetic core 12, the integrated inductive device 1 is substantially shaped like a triangular prism, and therefore is smaller in volume and structurally compact, thereby increasing the space utilization rate.

The axes L1, L2, L3 of the inductive coils 13, 14, 15 are parallel to one another and perpendicular to the first end magnetic core 11 and the second end magnetic core 12, so that the integrated inductive device 1 is structurally more compact and smaller in volume.

Any two of the axes L1, L2, L3 of the inductive coils 13, 14, 15 are equally spaced, so that the magnetic fluxes in the three separate inductive coils 13, 14, 15 are distributed more evenly.

The recesses on the second end surface of the first end magnetic core 11 and the recesses on the second end surface of the second end magnetic core 12 enable the columnar magnetic cores to be firmly inserted therein, making the structure of the integrated inductive device 1 firmer as well as reducing the consumption of magnetic material.

The insulating cover 16 and the insulating cover 17 are used to electrically isolate the first end magnetic core 11 and the second end magnetic core 12 from the inductive coils 13, 14, 15 while preventing the first end magnetic core 11 and the second end magnetic core 12 from damaging an enamel coating or insulating layer on the inductive coils 13, 14, 15.

The annular flange and the clamping rings on the insulating cover 16 enable the insulating cover 16 to be tightly fitted and connected to the first end magnetic core 11, the annular flange and the clamping rings on the insulating cover 17 enable the insulating cover 17 to be tightly fitted and connected to the second end magnetic core 12, and the area of insulation is further increased.

Owing to the identical shapes of the first end magnetic core 11 and the second end magnetic core 12, the identical shapes of the insulating cover 16 and the insulating cover 17, the identical shapes of the inductive coils 13, 14, 15 and the identical columnar magnetic cores 131, 141, 151, the number of molds needed is reduced, the manufacturing cost of the integrated inductive device is reduced, and the integrated inductive device is more suitable for assembly.

### Second Embodiment

FIG. 6 is an exploded diagram of an integrated inductive device according to the second embodiment of the present utility model. As shown in FIG. 6, the integrated inductive device 2 is substantially identical with the integrated inductive device 1 shown in FIG. 5 except for the following points. The first end magnetic core 21 is provided with a first magnetic core through hole 213 running through its first end surface 211 and second end surface 212, and the first magnetic core through hole 213 is triangular and located in the middle of the three recesses (not shown in FIG. 6) on the second end surface 212 of the first end magnetic core 21. The second end magnetic core 22 is provided with a second magnetic core through hole 223 running through its first end surface 221 and second end surface 222, and the second magnetic core through hole 223 is triangular and located in the middle of the three recesses 2221, 2222, 2223 on the second end surface 222 of the second end magnetic core 22.

The insulating cover 26 includes a triangular cover through hole 266 and a clamping ring 2661. The cover through hole 266 is located in the middle of the three through holes 263, 264, 265 on the insulating cover 26. The clamping ring 2661 is aligned with sidewalls of the cover through hole 266 and extended toward the first magnetic core through hole 213. The insulating cover 27 includes a triangular cover through hole 276 and a clamping ring (not shown in FIG. 6). The cover through hole 276 is located in the middle of the three through holes 273, 274, 275 on the insulating cover 27. The clamping ring on the insulating cover 27 abuts against sidewalls of the cover through hole 276 and extends toward the second magnetic core through hole 223.

FIG. 7 is a schematic plan view of the integrated inductive device shown in FIG. 6 in the assembled state as viewed along a direction from the first end magnetic core to the second end magnetic core. As shown in FIG. 7, the first magnetic core through hole 213, the second magnetic core through hole 223, the cover through hole 266 and the cover through hole 276 have the same size and are aligned in a direction parallel to the axes of the inductive coils 23, 24, 25, so only the first magnetic core through hole 213 is shown in FIG. 7. DC biases are applied on the integrated inductive device 2 of the present embodiment to test its inductance value during the increase of DC current, and the results are shown in table 2 below.

TABLE 2
Inductance Values of Integrated Inductive Device
2 Under Different DC Bias Current Intensities

| | Integrated Inductive Device 2 | | |
|---|---|---|---|
| | Inductance Value (μH) | | |
| Current | Inductive | Inductive | Inductive |
| (A) | Coil 23 | Coil 24 | Coil 25 |
| 0 | 172 | 160 | 165 |
| 10 | 169 | 157 | 162 |
| 20 | 151 | 145 | 146 |
| 30 | 110 | 114 | 115 |
| 40 | 85.8 | 87.3 | 88.5 |
| 50 | 71.9 | 73.6 | 73.4 |
| 60 | 60.7 | 62.6 | 61.9 |
| 70 | 50.8 | 53 | 52.2 |
| 80 | 42.7 | 45 | 43.6 |
| 90 | 36.2 | 38.2 | 37 |
| 100 | 31 | 32.6 | 31.6 |

It can be known from table 2 that with the increase of DC bias current intensity, the inductances of the inductive coils in the integrated inductive device 2 all decrease nonlinearly, which is reasonable.

It can be known from the comparison between table 1 and table 2 that under the same DC bias current intensity, the inductance value of the integrated inductance device 2 is substantially the same as that of the integrated inductive device 1, so inductance parameters of the integrated inductive device 2 are not affected by the first magnetic core through hole 213, the second magnetic core through hole 223, the cover through hole 266 and the cover through hole 276. Compared with the integrated inductive device 1, the integrated inductive device 2 can further reduce the amount of material required for the manufacture of the magnetic cores without decreasing its magnetic induction performance, and therefore has higher cost effectiveness. The materials, weight and cost of the integrated inductive device 2 are further reduced.

The applicant has made further studies on a correspondence relationship between the shape characteristics of the first magnetic core through hole 213 and the second magnetic core through hole 223 and corresponding magnetic induction performances, and found that the magnetic field near the portions of the first end magnetic core 21 and the second end magnetic core 22 contacting the three columnar magnetic cores is a main magnetic field, while a surrounding area around the main magnetic field is non-main magnetic field. The applicant puts forwards that end magnetic core bodies at the surrounding non-main magnetic field area can be hollowed out without affecting the magnetic circuit of the main magnetic field, so as to enlarge the first magnetic core through hole 213 and the second magnetic core through hole 223 as much as possible under the premise of not losing magnetic induction performance. Since the first magnetic core through hole 213 and the second magnetic core through hole 223 are identical, only the first magnetic core through hole 213 is taken as an example for illustration. In FIG. 7, the first magnetic core through hole 213 perpendicularly running through the first end magnetic core 21 has a triangular shape substantially concentric with the triangular first end magnetic core 21. Moreover, the triangular hollow area is sized to be separated from or does not overlap with the respective recesses near its three vertexes. Therefore, when viewed from the perspective of FIG. 7 in which the three recesses 2121, 2122, 2123 on the second end surface 212 of the first end magnetic core 21 are respectively shown by round dashed lines, the three recesses 2121, 2122, 2123 are separated from or do not overlap with the triangle first magnetic core through hole 213. The first end magnetic core and the second end magnetic core designed in this way can ensure that the first end and second end of each of the columnar magnetic cores arranged between the first end magnetic core and the second end magnetic core are completely in tight contact with a magnetic core body portion at a bottom wall of a corresponding recess of the first end magnetic core or the second end magnetic core without being exposed in the free space of the first magnetic core through hole 213 or the second magnetic core through hole 223. Therefore, the possibility of the magnetic field leaking from the first end and second end of the columnar magnetic core is eliminated, thereby ensuring that the magnetic field in the columnar magnetic core is guided to only pass through the first end magnetic core 21 or the second end magnetic core 22, which reduces the loss caused by magnetic leakage.

In a preferred embodiment, viewed in a direction from the first end magnetic core to the second end magnetic core, the hollow portion defined by the first magnetic core through hole perpendicularly running through the first end magnetic core 21 may also be larger than the first magnetic core through hole 213 shown in FIG. 7. For example, the three vertexes of the triangle formed by the first magnetic core through hole may adjoin the corresponding adjacent recesses 2121, 2122, 2123 without overlapping with the recesses.

In other embodiments as further variants, as viewed in a direction from the first end magnetic core to the second end magnetic core, the first magnetic core through hole does not have to be triangular but other shapes further expanded in the body portion of the first end magnetic core except the round portions occupied by the three recesses, as long as it is ensured that the recess portions of the first end magnetic core do not overlap with the first magnetic core through hole and do not cause the end surfaces of the columnar magnetic cores to be exposed to the external environment.

The first magnetic core through hole or the second magnetic core through hole arranged in this way can further reduce the consumption of magnetic material on the basis of ensuring less magnetic leakage, thereby further reducing the cost.

The present utility model is not intended to limit the shapes of the first magnetic core through hole 213, the second magnetic core through hole 223, the cover through hole 266 and the cover through hole 276 to be triangular. In other embodiments, the shapes of the first magnetic core through hole 213, the second magnetic core through hole 223, the cover through hole 266 and the cover through hole 276 may be round, elliptic, square, hexagonal, polygonal or or any combination thereof.

### Third Embodiment

FIG. 8 is a schematic plan view of an integrated inductive device according to the third embodiment of the present utility model in the assembled state as viewed along a direction from a first end magnetic core to a second end magnetic core. As shown in FIG. 8, the integrated inductive device 3 is substantially identical with the integrated inductive device 1 shown in FIG. 4, except that insulating markers 3323, 3423, 3523 are respectively sheathed on a first outlet end 3321 of the inductive coil 33, a first outlet end 3421 of the inductive coil 34 and a first outlet end 3521 of the inductive coil 35.

The insulating markers 3323, 3423, 3523 may be insulating sleeves, color-coded collars or insulating tapes, or have coatings, recesses or bumps in the shape of “AC”, “A”, “B” or “C”, which are used to mark the power terminals for connecting to three-phase alternating-current.

When the integrated inductive device 3 is connected to a three-phase power factor correction circuit, the first outlet end 3321, the first outlet end 3421 and the first outlet end 3521 with the insulating markers 3323, 3423, 3523 are respectively connected to the three-phase alternating-current power terminals, so that the inductive coil 33, the inductive coil 34 and the inductive coil 35 generate magnetic fields in the same direction. Therefore, the misconnection of the inductive coils is avoided, and detection time and assembly time are shortened.

In another embodiment of the present utility model, the integrated inductive device is substantially identical with the integrated inductive device 3 shown in FIG. 8, except that the insulating marker 3523 is sheathed on the second outlet end 3522 of the inductive coil 35. When the integrated inductive device is connected to a single-phase interleaved parallel power factor correction circuit or an interleaved parallel DC-DC circuit, it is just needed to connect the outlet ends provided with the insulating markers to the power terminals.

In another embodiment of the present utility model, the integrated inductive device is substantially identical with the integrated inductive device 1 shown in FIG. 4, except for the following points. The first inductive coil and the second inductive coil are wound in the same direction, while the third inductive coil is wound in an opposite direction; and insulating markers are arranged on the first outlet end of the first inductive coil and the first outlet end (close to the first end magnetic core) of the second inductive coil and the second outlet end (close to the second end magnetic core) of the third inductive coil. When the integrated inductive device is connected to a three-phase power factor correction circuit, it is only needed to connect the outlet ends provided with the insulating markers to the power terminals.

In another embodiment of the present utility model, the integrated inductive device is substantially identical with the integrated inductive device 1 shown in FIG. 4, except for the following points. The winding directions of the first inductive coil and the second inductive coil are wound in the same direction, while the third inductive coil is wound in an opposite direction; and close to one side of the first end magnetic core, insulating markers are arranged on the first outlet end of the first inductive coil, the first outlet end of the second inductive coil and the first outlet end of the third inductive coil. When the integrated inductive device is connected to a single-phase interleaved parallel power factor correction circuit or an interleaved parallel DC-DC circuit, it is only needed to connect the outlet ends provided with the insulating markers to the power terminals.

In another embodiment of the present utility model, the numbers of turns of the three inductive coils may be different.

In other embodiments of the present utility model, the columnar magnetic cores are cylinders, cuboids, hexagonal prisms or other columnar shapes, and the shapes of the recesses on the second end surfaces of the first end magnetic core and the second end magnetic core match the shapes of the ends of the corresponding columnar magnetic cores.

In other embodiments of the utility model, the second end surfaces of the first end magnetic core and the second end magnetic core are not provided with recesses, where the opposite ends of each of the columnar magnetic cores are respectively attached to the second end surface of the first end magnetic core and the second end surface of the second end magnetic core.

In other embodiments of the present utility model, the inductive coils wound outside respective columnar magnetic cores are round enameled wires, round cables or wires with other cross-sectional shapes.

Although the present utility model has been described by way of the preferred embodiments, the present utility model is not limited to the embodiments described herein, but also includes various alterations and changes made without departing from the scope of the present utility model.

1. An inductive device, comprising:
three columnar magnetic cores arranged such that longitudinal axes of the columnar magnetic cores define a triangle in a plane transverse to the longitudinal axes;
first and second end magnetic cores disposed at respective first and second ends of the columnar magnetic cores; and
inductive coils on respective ones of the columnar magnetic cores between the first end magnetic core and the second end magnetic core.

2. The inductive device of claim 1, wherein the first end magnetic core and the second end magnetic core comprise respective triangular plates.

3. The inductive device of claim 1, wherein the longitudinal axes of the columnar magnetic cores are parallel to one another and perpendicular to the first end magnetic core and the second end magnetic core.

4. The inductive device of claim 1, wherein:
the first end magnetic core has three first recesses therein into which the columnar magnetic cores are inserted; and
the second end magnetic core has three second recesses therein into which the columnar magnetic cores can be are inserted.

5. The inductive device of claim 4, wherein the first end magnetic core has a first core through hole therein positioned at a centroid of a triangle defined by the three first recesses and wherein the second end magnetic core has a second through hole therein positioned at a centroid of a triangle defined by the three second recesses.

6. The inductive device of claim 5, wherein as viewed in a direction parallel to the longitudinal axes of the columnar magnetic cores, the first through hole is separated from the three first recesses, or the second through hole is separated from the three second recesses.

7. The inductive device of claim 5, wherein the first through hole and the first end magnetic core are concentric triangles and
wherein the second magnetic core through hole and the second end magnetic core are concentric triangles.

8. The inductive device of claim 1, further comprising a first insulating cover located between the first end magnetic core and the three inductive coils and a second insulating cover located between the second end magnetic core and the three inductive coils.

9. The inductive device of claim 8, wherein the first insulating cover comprises:
an insulating sheet covering a surface of the first end magnetic core and having three through holes respectively aligned with the three first recesses;
a flange at a periphery of the insulating sheet; and
three clamping rings which extend toward the three first recesses and on to inner sidewalls of the three first recesses.

10. The inductive device of claim 1, wherein the inductive device further comprises three insulating sheaths on the three columnar magnetic cores.

11. An inductive device comprising:
first, second and third magnetic core column members having parallel longitudinal axes;
first and second magnetic core end members at respective first and second ends of the magnetic core column members and having recesses therein that receive the first and second ends of the first, second and third magnetic core column members; and
first, second and third coils on respective ones of the first, second and third magnetic core column members between the first and second magnetic core end members.

12. The inductive device of claim 11, wherein the first and second magnetic core end members have triangular surfaces and wherein the recesses are arranged in the triangular surfaces in a triangular pattern such that the longitudinal axes of the first, second and third magnetic core column members define a triangle in a plane perpendicular to the longitudinal axes.

13. The inductive device of claim 12, further comprising first and second insulating covers between the first, second and third coils and respective ones of the first and second magnetic core end members.

14. The inductive device of claim 13, wherein the first and second insulating covers have holes therein through which the first, second and third magnetic core column members pass.

15. The inductive device of claim 14, wherein the first and second insulating covers conform to the triangular surfaces of the first and second magnetic core end members and have peripheral flanges aligned with outside edges of the first and second magnetic core end members.
